(19) United States
(12) Patent Application Publication
(10) Pub. No.: US 2026/0071659 A1
(43) Pub. Date: Mar. 12, 2026

(54) STRUCTURAL RIB FOR A DISC BRAKE CALIPER BODY

(71) Applicant: Fox Factory, Inc., Duluth, GA (US)

(72) Inventor: Bill Becker, Aptos, CA (US)

(21) Appl. No.: 18/828,931

(22) Filed: Sep. 9, 2024

(51) Int. Cl. F16D 65/00; F16D 55/00

(52) U.S. Cl. CPC F16D 65/0068; F16D 2055/0016

(57) ABSTRACT

A disc brake caliper with a structural rib is provided. The disc brake caliper includes a disc brake caliper body having a leading mounting boss and a trailing mounting boss. The disc brake caliper body is configured to couple over a rotor of a vehicle. The disc brake body also includes a structural rib extending from the trailing mounting boss to the disc brake caliper body in a location adjacent to a trailing piston portion of the disc brake caliper body. In use, the disc brake caliper may be coupled to a rotor of a vehicle. In response to activating the disc brake during rotation of the rotor the disc brake caliper with structural rib reduces deflection of the inner trailing piston portion of the disc brake caliper body in comparison to a disc brake caliper without a structural rib.

### BACKGROUND OF THE INVENTION

### Technical Field

This invention relates generally to disc brakes and more particularly to a structural rib for a disc brake caliper body.

### State of the Art

On a disc brake system, the disc brake caliper is placed over a disc brake rotor. The stiffness of the disc brake caliper is important when braking hard in order to give the driver/rider a good, solid, predictable linear brake feel and modulation. The desirable function is to have the brakes feel firm and eliminate a soft or springy response with respect to brake lever or brake pedal force input. A great amount of design in the disc brake system is to minimize the “soft, springiness” feel which translates to unwanted excessive brake lever movement.

Accordingly, in order to minimize the “soft, springiness” feel of the brake and reduce unwanted excessive brake lever movement, an improved structural rib for a disc brake caliper body is needed.

### SUMMARY OF THE INVENTION

An embodiment includes a disc brake caliper comprising: a disc brake caliper body having a leading mounting boss and a trailing mounting boss, the disc brake caliper body configured to couple over a rotor of a vehicle; and a structural rib extending from the trailing mounting boss to the disc brake caliper body in a location adjacent to a trailing piston portion of the disc brake caliper body.

Another embodiment includes a method of using a disc brake caliper, the method comprising: coupling a disc brake caliper to a rotor of a vehicle, wherein the disc brake caliper comprises: a disc brake caliper body having a leading mounting boss and a trailing mounting boss, the disc brake caliper body configured to couple over a rotor of a vehicle; and a structural rib extending from the trailing mounting boss to the disc brake caliper body in a location adjacent to a trailing piston portion of the disc brake caliper body; activating the disc brake during rotation of the rotor; and reducing deflection of the inner trailing piston portion of the disc brake caliper body in response to support provided by the structural rib, wherein the deflection is reduced in comparison to a disc brake caliper without a structural rib.

The foregoing and other features and advantages of the present invention will be apparent from the following more detailed description of the particular embodiments of the invention, as illustrated in the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 is a perspective view of a prior art disc brake caliper body with a standard mounting boss;

FIG. 2 is a perspective view of caliper body with a structural rib coupled to a rotor according to an embodiment;

FIG. 3 is a side view of caliper body with a structural rib coupled to a rotor according to an embodiment; and

FIG. 4 is a flow chart depicting a method of using a disc brake caliper with a structural rib according to an embodiment.

### DETAILED DESCRIPTION OF EMBODIMENTS OF THE INVENTION

As discussed above, embodiments of the present invention relate to a structural rib for a disc brake caliper body to minimize the “soft, springiness” feel of the brake and reduce unwanted excessive brake lever movement.

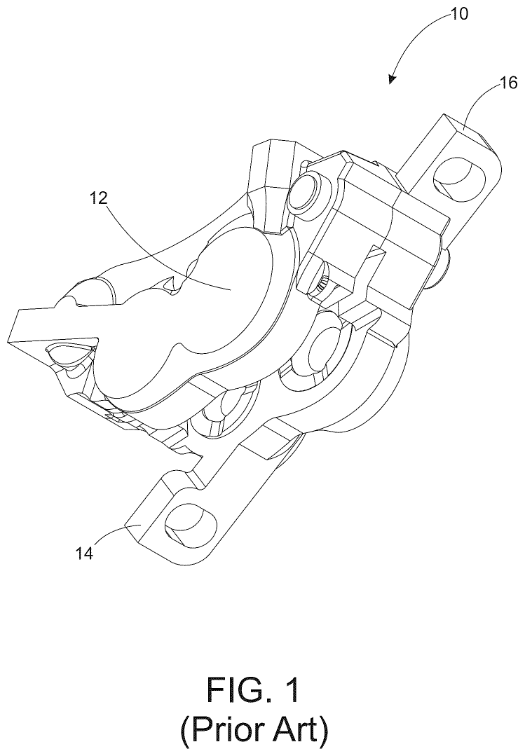

As shown in FIG. 1, a prior art embodiment of a brake caliper 10 is depicted. The brake caliper 10 includes a brake caliper body 12 with a leading mounting boss 14 and a trailing mounting boss 16. This embodiment lacks a structural rib and therefore operates with a great “soft, springiness”feel and includes unwanted brake lever movement.

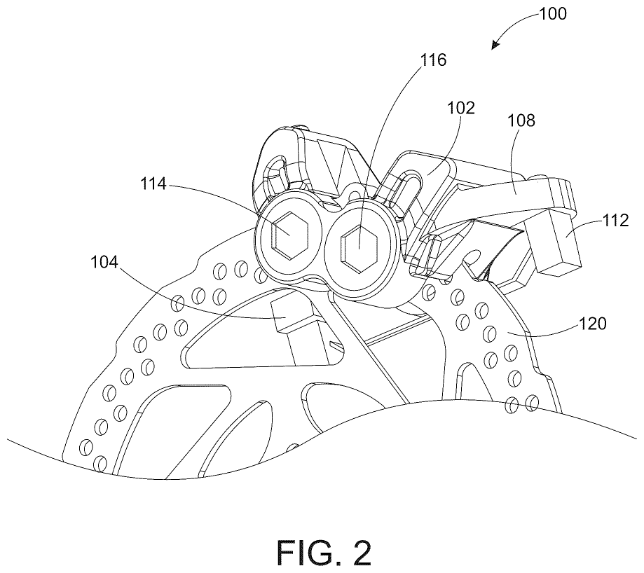

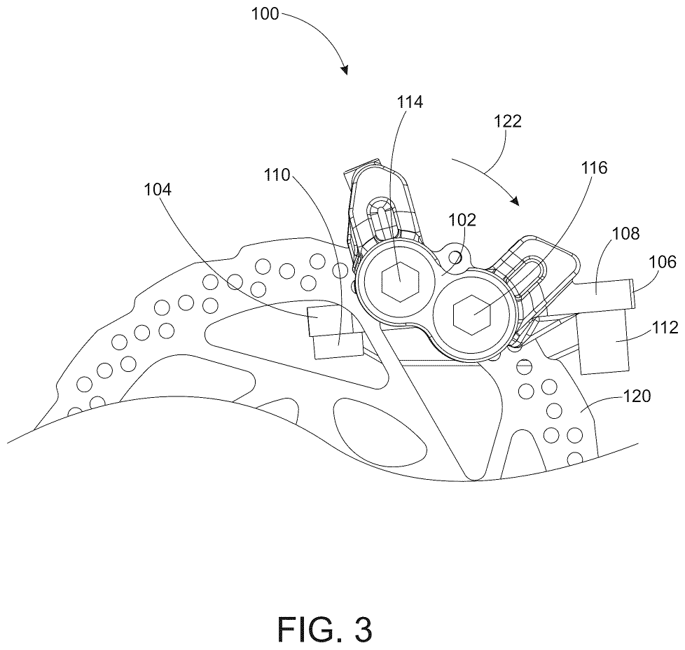

In contrast to the prior art embodiment of FIG. 1, an embodiment of a new improved brake caliper 100 is depicted in FIGS. 2 and 3. The brake caliper 100 includes a brake caliper body 102 with a leading mounting boss 104 and a trailing mounting boss 106. The brake caliper 100, as shown in the drawing figures includes a leading piston portion 114 and a trailing piston portion 116, wherein brake pistons are coupled within the leading piston portion 114 and the trailing piston portion 116. Additionally, the brake caliper 100 includes a structural rib 108 extending between the trailing mounting boss 106 and the brake caliper body 102 adjacent the trailing piston 116 of the brake caliper 100.

In operation, the brake caliper body 102 is coupled over a rotor 120 by coupling the leading mounting boss 104 to a leading mounting bracket 110 and coupling the trailing mounting boss 106 to a trailing mounting bracket 110. The rotor 120 rotates during operation of the vehicle in a direction indicated by arrow 122, which determined the leading piston 114 and the trailing piston portion 116. In this embodiment, the structural rib 108 is located in a position to avoid interference with the rotor 120 of the vehicle when the disc brake caliper 100 is coupled to the rotor 120. The structural rib 108 greatly reduces the deflection of the inner trailing piston portion 116 of a disc brake caliper 100 when compared to prior art calipers, such as prior art caliper 10 depicted in FIG. 1.

In these embodiments of disc brake caliper 100 with the structural rib 108, they provide a good, solid, predictable linear brake feel and modulation, particularly with brake hard or up to max breaking force applied. This predictable linear brake feel and modulation is what minimizes the “soft, springiness” feel of the brake and reduces unwanted excessive brake lever movement.

While it is shown in FIGS. 2 and 3 that the structural rib 108 is being used on a four-piston brake caliper 100, other size brake calipers may be utilized, such as two-piston or six-piston disc brake calipers without departing from the scope of the present invention.

As depicted in FIG. 2, the structural rib 108 may be a partial conic or partial elliptical shape. The most structurally efficient structural rib shape is a partial conic or partial elliptical shape. The advantage to such a conic/elliptical shaped structural rib 108 is that it is the stiffest and lightest shape to minimize deflection under a max brake pressure load. This is critical vehicles, particularly vehicles that race, to have a high strength, light weight component to provide the strength necessary while maintaining a light vehicle when every ounce of weight matters in overall speed of the vehicle.

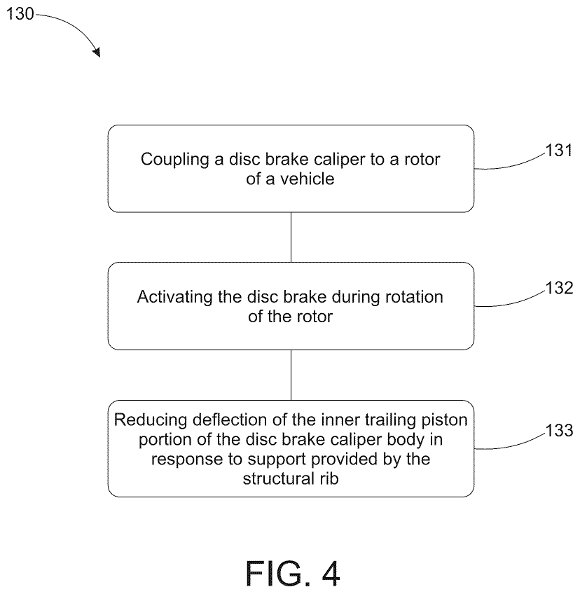

Referring to the drawings, FIG. 4 depicts a method 130 of using a disc brake caliper with a structural rib. The method 130 comprises coupling a disc brake caliper to a rotor of a vehicle (Step 131); activating the disc brake caliper during rotation of the rotor (Step 132); and reducing deflection of the inner trailing piston portion of the disc brake caliper body in response to support provided by the structural rib (Step 133), wherein the deflection is reduced in comparison to a disc brake caliper without a structural rib. The disc brake caliper of method 130 comprises a disc brake caliper body having a leading mounting boss and a trailing mounting boss, the disc brake caliper body configured to couple over a rotor of a vehicle; and a structural rib extending from the trailing mounting boss to the disc brake caliper body in a location adjacent to a trailing piston portion of the disc brake caliper body.

The method 130 may further comprise providing predictable linear brake feel and modulation in response to reducing deflection of the inner trailing piston portion of the disc brake caliper body; and providing predictable linear brake feel and modulation comprises reducing unwanted excessive brake lever movement when compared to a disc brake caliper without a structural rib. Additionally, the partial conic or partial elliptical shape provides a method step of maximizing weight and structural stiffness during braking in response to the partial conic shape of the structural rib compared to other shaped structural ribs.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A disc brake caliper comprising:
a disc brake caliper body having a leading mounting boss and a trailing mounting boss, the disc brake caliper body configured to couple over a rotor of a vehicle; and
a structural rib extending from the trailing mounting boss to the disc brake caliper body in a location adjacent to a trailing piston portion of the disc brake caliper body.

2. The disc brake caliper of claim 1, wherein the structural rib is a partial conic shape.

3. The disc brake caliper of claim 1, wherein the structural rib is a partial elliptical shape.

4. The disc brake caliper of claim 1, wherein the structural rib is located in a position to avoid interference with a rotor of a vehicle when the disc brake caliper is coupled to the rotor.

5. A method of using a disc brake caliper, the method comprising:
coupling a disc brake caliper to a rotor of a vehicle, wherein the disc brake caliper comprises:
a disc brake caliper body having a leading mounting boss and a trailing mounting boss, the disc brake caliper body configured to couple over a rotor of a vehicle; and
a structural rib extending from the trailing mounting boss to the disc brake caliper body in a location adjacent to a trailing piston portion of the disc brake caliper body;
activating the disc brake during rotation of the rotor; and
reducing deflection of the inner trailing piston portion of the disc brake caliper body in response to support provided by the structural rib, wherein the deflection is reduced in comparison to a disc brake caliper without a structural rib.

6. The method of claim 5, further comprising providing predictable linear brake feel and modulation in response to reducing deflection of the inner trailing piston portion of the disc brake caliper body.

7. The method of claim 6, wherein providing predictable linear brake feel and modulation comprises reducing unwanted excessive brake lever movement when compared to a disc brake caliper without a structural rib.

8. The method of claim 5, wherein the structural rib is a partial conic shape.

9. The method of claim 8, further comprising minimizing weight and maximizing structural stiffness during braking in response to the partial conic shape of the structural rib compared to other shaped structural ribs.

10. The method of claim 5, wherein the structural rib is a partial elliptical shape.

11. The method of claim 10, further comprising minimizing weight and maximizing structural stiffness during braking in response to the partial elliptical shape of the structural rib compared to other shaped structural ribs.

12. The method of claim 5, wherein the structural rib is located in a position to avoid interference with a rotor of a vehicle when the disc brake caliper is coupled to the rotor.
